(19) United States
(12) Patent Application Publication
(10) Pub. No.: US 2015/0307217 A1
(43) Pub. Date: Oct. 29, 2015

(54) FOOD PRESERVATION SYSTEM

(71) Applicant: Fresh Box LLC, Cary, NC (US)

(72) Inventors: Allison Marie Fairbank, Cary, NC (US); Kornkanok Sintavanon, Richmond, VA (US); Jarrett Bliton, Madison, WI (US); Leroy Edward Tropp, IV, Oxford, MS (US)

(73) Assignee: Fresh Box LLC, Cary, NC (US)

(21) Appl. No.: 14/691,657

(22) Filed: Apr. 21, 2015

Related U.S. Application Data
(60) Provisional application No. 61/983,227, filed on Apr. 23, 2014.

(51) Int. Cl. B65B 25/00; B65B 5/04; B65B 7/16; A23L 3/3418

(52) U.S. Cl. CPC B65B 25/001; A23L 3/3418; B65B 5/04; B65B 7/16; A23V 2002/00

(57) ABSTRACT

The present invention relates to using a food preservation gas to flush ambient air from a food retaining space in a container, and replacing the ambient air with the food preservation gas without having to utilize a vacuum to remove ambient air like previous systems. This allows a simple home device to be utilized where previous systems were larger and more expensive.

This application claims priority of U.S. provisional application 61/983,227 filed on Apr. 23, 2014 and is included herein in its entirety by reference.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a food preservation system. In particular, the invention relates to a modified atmosphere system of food preservation.

2. Description of Related Art

The preservation of foods is almost as old as the consumption of food by man. Both commercial and home methods of preservation are numerous and each has its benefits and drawbacks. These preservation methods include; chemical preservation, refrigeration, freezing, drying, canning, vacuum, inert gasses and the like.

One of the more recent methods of preservation involves the removal of air from a package of food, followed by reintroduction of an inert gas such as nitrogen, carbon dioxide and/or argon. This has been titled Modified Atmosphere Packaging, or MAP, and is used extensively on a large commercial scale worldwide because of the great success with foods such as breads, cakes, cheeses, coffee, cooked and fresh meats, pasta, fruit, milk, seafood, vegetables and ready to eat meals. Until recently, the closest types of food preservation available for home use have been vacuum machines and wine preservation systems, which introduce an inert gas over the surface of an open bottle of wine.

More recently, the introduction of a simplified MAP system for home use was patented in 2011 as U.S. Pat. No. 8,020,360, by the Whirlpool corporation. In this method, a smaller scale home device creates a vacuum, and then replaces the vacuum with from one to three inert gases (preservation gases). While this is certainly more cost-effective than the large commercial MAP systems, it is still very expensive to combine both vacuum and gas introduction in the same device. It does not appear that Whirlpool or any other company actually sells a home MAP system. There is a need for better, more cost-effective food preservation systems which allow the home user to benefit from what many think is the best way to preserve foods for an extended period of time.

### BRIEF SUMMARY OF THE INVENTION

The present invention relates to a modified MAP system wherein two one-way valves are utilized to introduce a preservation gas in the first valve and flush air out of the second valve. The size of the container determines the flushing time, a timer keeps time as a solenoid or other electronic valve or mechanical valve is open for the specific period of time to flush the container and leave a preservation gas behind. The flushing thus eliminates the need for a vacuum step and eliminates the expense a vacuum step would entail. Since mixtures of gases are utilized, having premixed gases of specific ratios further eliminates the need to regulate mixtures from two or more tanks of individual gases. It also removes the need for other devices, such as vacuum devices, devices for switching between a vacuum device and a canister, regulators between gas canisters, circuits for determining if gases have been removed and the like.

### BRIEF DESCRIPTION OF THE DRAWINGS

FIG. 1 is a schematic of the system of the present invention.

FIG. 2 is a container of the invention.

FIG. 3 is the appliance module of the present invention.

FIG. 4 is a flow chart of the method of the invention.

### DETAILED DESCRIPTION OF THE INVENTION

While this invention is susceptible to embodiment in many different forms, there is shown in the drawings, and will herein be described in detail, specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### Definitions

The terms “about” and “essentially” mean ±10 percent.

The terms “a” or “an”, as used herein, are defined as one or as more than one.

The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as a limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the term “food preservation” refers to the placement of fresh or cooked food such as meat, dairy, fruits, coffee, leftovers, vegetables and the like in a container system for the purpose of extending the shelf life of the food. In particular, in the present invention food preservation refers to storage of food in the presence of a food preservation gas. A food preservation system then is a system of parts that, when used together, allows for the preservation of food.

As used herein the term “sealable food container” refers to a container which when closed (sealed) can generally prevent the ingress or egress of gasses into or out of the container. The container is made of material compatible with food, such as food grade polypropylene or glass and the like and can be rigid (such as shown in the figures) or flexible (such as storage bag type containers). In one embodiment, as shown in the figures, there is a rigid container with a generally flat top that has a gasket seal between the two for sealing purposes. The container can snap in place, screw in place, or have fold down locks or the like and such type of container is generally well known in the art. Generally, the seal does not have to be effective at more than about 1, 2, or 3 atmospheres of pressure. The container can be virtually any size and size variation in sealable containers is well known in the art. So, for example, the container food retaining space could be 1, 2, 3, 4, 5, 6, 7, 8, 9, 10, 15, 20 cups or more. In one embodiment, the container food retaining space is one quart or less in size. The containers, if rigid, could be round or rectangular or the like as desired.

As used herein the term “food retaining space” refers to the space inside the sealable food container where food is placed for preservation. As noted above, the container will have a specific selected volume for food of a specific size.

As used herein the term “one way inlet valve” refers to a valve placed on a side of the food container e.g. in the lid, where a connector can hook up to it. This connector can be used for introducing a gas into the food retaining space via the one way inlet valve when the container is in a sealed condition starting with an ambient interior (just closing and sealing it with food inside and nothing else). The connector would be in fluid communication with one or more gas canisters, each containing one or more gases and connected to the inlet valve. The idea being once a gas goes into the inlet valve it cannot come back out, as pressure is increased inside the food container. So, for example, in one embodiment the inlet valve is a commercially available such as a cross-slit valve, a duck bill valve or an umbrella valve.

As used herein the term “one way outlet valve” refers to a valve placed on a side of the food container e.g. the lid, such that when the pressure inside the food retaining space exceeds a certain predetermined amount, e.g. 1 atmosphere or more, the valve automatically opens to relieve the pressure inside the food retaining space, and gas inside the container nearest the valve escapes from the container.

By placement of the inlet and outlet valves apart from one another (see e.g. the figures) as a preservation gas is added to the inlet valve the oxygen-containing, ambient air is forced out the outlet valve. Initially, only ambient air leaves. As the container's food retaining space is filled with the preservation gas, some of the preservation gas begins leaving the container as well. While in general, this method does not eliminate as much of the ambient air as a total vacuum, it does remove enough ambient air such that only about 3-5% of the remaining atmosphere, or less, is ambient oxygen containing air. This works essentially as well as using vacuum gas withdrawal in a 2-step process. If one measures the gas pressure (by use of a regulator) and the gas force, the time, and the result, it would be within the skill in the art to determine how much time gas can be run into the container to optimize the purge of the ambient air versus wasting the preservation air out the outlet. This becomes the optimum time to run the system for each size container. The ideal time terms can be so calculated and provided as part of the system.

As used herein the term “gas introduction module” refers to an appliance for the introduction of a preservation gas into an inlet valve of a food container and food retaining space of the present invention, and purges the ambient air out of the outlet valve. The parts of the system include at least one gas canister of one or more food preservation gas; a gas regulator for each canister; a connector to connect the canister to the container inlet valve; a valve for opening and closing the line allows the flow from the regulator to start/stop, and a time control circuit for opening and closing the electronic valve for a set period of time.

As used herein the term “food preservation gas” refers to those gases known to retard the spoilage of food, for example, carbon dioxide, nitrogen gases and the like. Only one canister at a time can be attached to the food preservation system (thus negating the need for a mixing valve when multiple gases are utilized). The gas canisters can contain a single gas preservation gas or a mixture of gases. In one embodiment, the gas canister contains a mixture of carbon dioxide and nitrogen gas from about 1% carbon dioxide to about 80% carbon dioxide. In one embodiment, the gas canister mixture contains about 50% carbon dioxide, and in another embodiment about 30% carbon dioxide, and in another embodiment about 5% carbon dioxide.

As used herein the term “gas regulator” refers to a device on each gas canister utilized to keep the pressure coming out of the canister constant. By keeping the pressure constant, the same amount of gas comes out of the canister in the same amount of time, every time. So, for example, when the canister is opened for 10 seconds there is always the same amount of gas coming out of the canister and into the food retaining space. Since each canister is connected independently (though they may share a single connector or regulator), they may have differing amounts of gas in them so they need their own regulator in one embodiment. In another embodiment there is a single regulator which is utilized and shared.

As used herein the term “connector” refers to a device for connecting the gas canister to the one way inlet valve. So the canister has a regulator which, when open, gas travels from the canister through a tube and into a device that can introduce the gas into the inlet valve. In one embodiment, it is a basketball type valve pin and the inlet valve is a basketball type (or other sports ball type) one way inlet valve.

As used herein the term “electronic or mechanical valve” refers to a valve on the canister which can be opened and closed to allow gas to flow or stop the flow of the gas from the canister. It can be placed before or after the regulator as desired. The valve opening and closing is controlled by a “time control circuit” where the user can set the time and canister to be utilized or by the user opening and closing the valve for a predetermined time i.e. manual “time control circuit” for purposes of the patent. So if canister No. 1 needs 10 seconds for a particular food retaining space, then the timer sends a signal to the valve to open for 10 seconds, while the regulator maintains the pressure of the gas, thus fixing the amount of gas to leave the canister and flow into the food retaining space. The set period of time can be programmed into the appliance, or can be set by the user, or both as desired. In one embodiment, the valve is a solenoid type, electronic valve, which is known within the art.

In the method of the present invention, the user then selects the food preservation system as described above. The food to be preserved is placed in the food retaining space and the container is sealed. The connector from the gas introduction module is attached to the gas inlet valve, the canister selected for use, and the timer engaged for at least a sufficient amount of time to flush the food retaining space of essentially all the ambient air and replace it with the one or more food preservation gases as described above. The present system can be tabletop, handheld, or any convenient size. If a smaller (handheld) system is being utilized, the canisters and the connectors can be proportionally smaller.

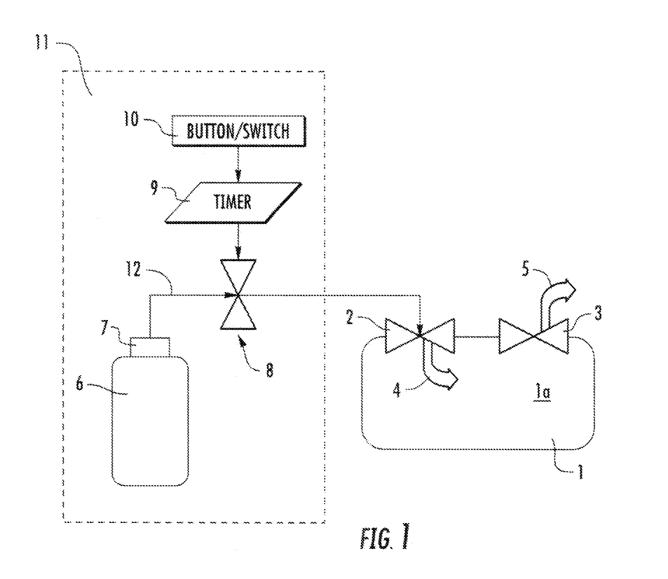

Now referring to the drawings, FIG. 1 is a schematic of the system of the present invention. In this view, a sealable food container 1 having a food retaining space 1a, and a top (lid) of the food container 1 has an inlet valve 2 and an outlet valve 3. Shown is food preservation gas 4, entering the food container 1, and ambient air 5 leaving the container 1. The gas introduction module 11 comprises a button switch programming faceplate 10 or the like for turning the machine on and doing any settings required. The timer 9 sets the amount of time the gas will pass from canister 6 to food retaining space 1a. A gas regulator 7 regulates the connector 12, which is opened or closed via valve 8, which is opened and closed by the timer 9.

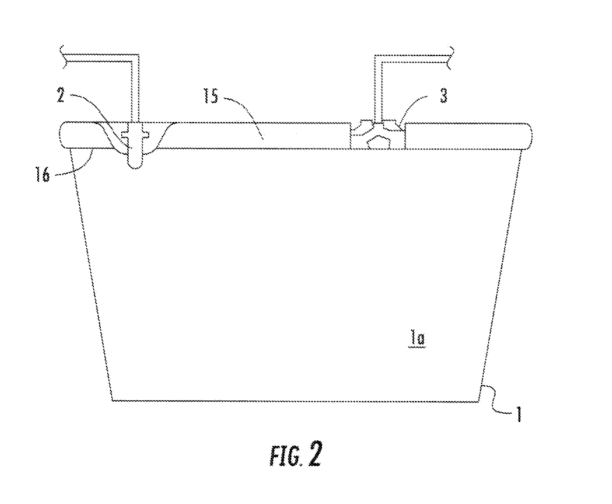

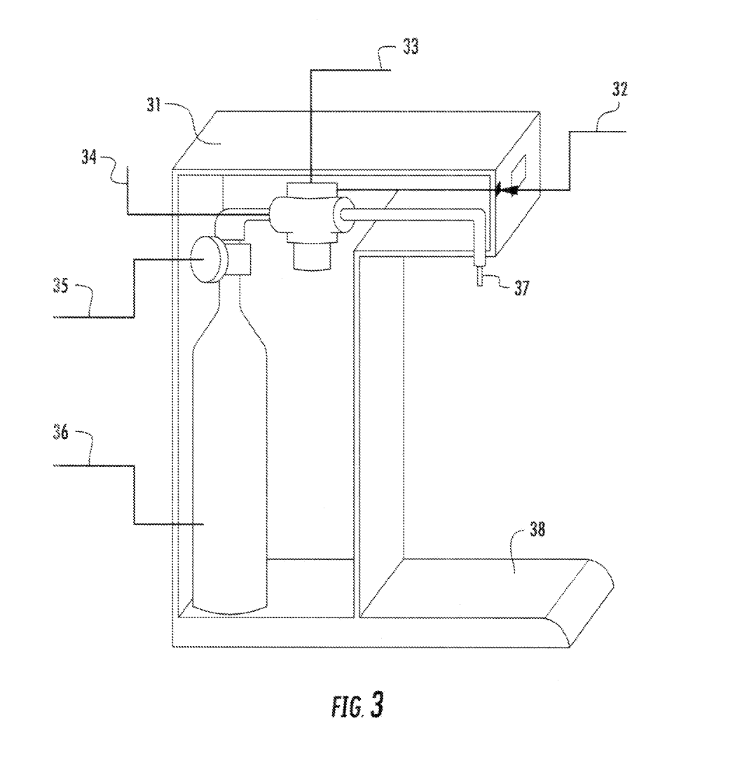

FIG. 2 is a side view of a food container of the invention showing the inlet valve 2 and outlet valve 3. Also shown is lid 15 and seal 16. The gas introduction module 31 is shown in FIG. 3. The gas introduction module 31 consists of an on/off button 32 which can also control a timer 33 for opening and closing the valve (a solenoid valve in this example) 34 of gas canister 36 regulated by regulator 35. Gas passes from the canister 36 to connector 37 designed to be placed into inlet valve 2 shown in FIG. 2, for example. While one canister is shown for simplicity, multiple canisters, for example four canisters, are contemplated in this drawing. In this embodiment, the appliance 31 has shelf 38 for setting a food container on. While the connection is shown as rigid in this embodiment, there could be a hose connector so that the canister can sit on the table and not be moved up to the connector 37.

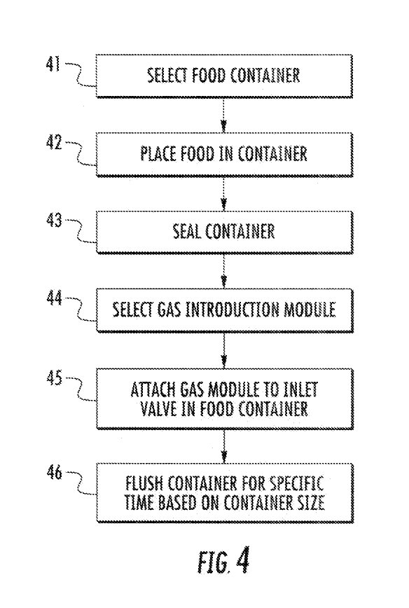

FIG. 4 shows a flow chart of the method of the present invention. In the method, the system of the present invention is selected and the food container 41 is picked. Next, the food to be preserved is placed in the container 42, and the container sealed 43. The gas introduction module is then selected 44, the gas introduction module is then attached to the food container 45 by a connection from a food canister to the inlet valve on the food container. The gas introduction module is engaged for a specific time 46 so that gas flows from the gas introduction module to the container for a specific time based on container size.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. A system for food preservation comprising:
a) a sealable food container having a food retaining space of a specific volume and having a one-way inlet valve for introducing one or more preservation gases into the food retaining space and a one-way outlet valve which lets gas out of the food retaining space if the pressure in the space exceeds a predetermined amount; and
b) a gas introduction module for introducing one or more preservation gases into the food retaining space comprising:
i. at least one gas canister comprising one or more food preservation gases;
ii. a gas regulator regulating gas in each of the at least one gas canister;
iii. a connector for connecting a single gas canister to the one-way inlet valve for introduction of the one or more preservation gas in a single canister into the food retaining space;
iv. a valve for opening and closing the gas canister;
v. a time control circuit for opening and closing the electronic value for a set period of time.

2. The system according to claim 1 wherein the time control circuit opens and closes the valve for a time period based on the size of the food container.

3. The system according to claim 2 wherein the time period is a time sufficient to flush the ambient air from the sealable food container when in a sealed condition.

4. The system according to claim 1 wherein the food preservation gas in the gas canister is selected from at least one of carbon dioxide gas and nitrogen gas.

5. The system according to claim 4 wherein the gas in the gas canister comprises about 95% nitrogen and 5% carbon dioxide gases.

6. The system according to claim 4 wherein the gas in the gas canister comprises about 50% nitrogen and 50% carbon dioxide gases.

7. The system according to claim 5 wherein there are multiple gas canisters wherein only one gas canister can be attached to the food container.

8. The system according to claim 7 wherein there are four gas canisters, one containing nitrogen gas, one containing carbon dioxide gas, and two containing different mixtures of nitrogen and carbon dioxide gas.

9. The system according to claim 1 wherein the sealable food container is a resealable food container.

10. The system according to claim 9 wherein the food container seals with a sealing gasket.

11. The system according to claim 1 wherein the valve is an electronic valve.

12. The system according to claim 1 wherein the time control circuit is a manual time control circuit.

13. A method for preserving food comprising:
a) selecting a food preservation system according to claim 1;
b) placing the food in the food retaining space and sealing the container;
c) attaching the connector to the inlet valve; and
d) engaging the timer for a sufficient time to flush the food retaining space of essentially all the ambient air and replace it with one or more food preservation gases.
